(19) United States
(12) Patent Application Publication
(10) Pub. No.: US 2014/0331001 A1
(43) Pub. Date: Nov. 6, 2014

(54) Command Barrier for a Solid State Drive Controller

(71) Applicant: LSI Corporation, San Jose, CA (US)

(72) Inventors: Yang Liu, Milpitas, CA (US); Nital Patwa, San Jose, CA (US); Ming-Ju Lee, San Jose, CA (US); Yimin Chen, San Jose, CA (US); Changyou Xu, San Jose, CA (US); Tim Canepa, Los Gatos, CA (US)

(73) Assignee: LSI Corporation, San Jose, CA (US)

(21) Appl. No.: 14/268,957

(22) Filed: May 2, 2014

Related U.S. Application Data
(60) Provisional application No. 61/818,613, filed on May 2, 2013.

(51) Int. Cl. G06F 3/06

(52) U.S. Cl. CPC G06F 3/0659; G06F 3/0604; G06F 3/0679; G06F 2003/0697
USPC 711/103

(57) ABSTRACT

Methods and systems may perform one or more operations for solid state device administrative command execution including, but not limited to: receiving, in at least one administrative command queue, at least one administrative command affecting at least one submission queue; halting enqueuing of one or more submission commands in the at least one submission queue in response to the receiving the at least one administrative command affecting the at least one submission queue; adding at least one barrier command to at least one submission queue affected by the at least one administrative command; processing one or more commands in the at least one submission queue until the at least one barrier command in the at least one submission queue is processed; and processing the at least one administrative command affecting the at least one submission queue in response to the processing of the at least one barrier command.

### PRIORITY

The present application claims priority under 35 U.S.C. §119(e) to U.S. Provisional Patent Application Ser. No. 61/818,613, entitled ITERATIVE RESOURCE ALLOCATION FOR LARGE SECTOR FORMAT DRIVES, By Shu Li, et al., filed May. 2, 2013, which is currently co-pending, or is an application of which currently co-pending application(s) are entitled to the benefit of the filing date. The above-referenced provisional patent application is hereby incorporated by reference in its entirety.

### BACKGROUND

A plurality of interfaces may exist for transmission of data between a storage controller and a host storage device. For example, administrative commands sent between a host and the controller may be received over an interface (e.g. via an administrative queue) separate from normal data transfer commands sent between a host and controller (e.g. via one or more submission queues). When a host device inserts commands into one or more queues (administrative or submission), the storage controller may schedule the processing of those commands corresponding to those using an arbitration scheme.

It may be the case that the various commands (e.g. administrative commands vs. normal data commands) may be asynchronous in nature and/or may require different controller resources. In such a case, the processing order of commands cannot be guaranteed. For example, when a host sends down an administrative command via an administrative queue that affects one or more submission queues (e.g. a submission queue reset command), the states of commands in those submission queues may be unknown. Specifically, one of more of the affected commands may: (a) be resident in a queue and has not yet been fetched from the host memory yet; (b) be somewhere in flight within the controllor; or (c) be in flight to a completion queue on the host.

### SUMMARY

The present disclosures are directed to systems and methods for ensuring that one or more submission queues reach a known state prior to processing an administrative command affecting those submission queues. For example, upon receipt of an administrative command that affects a plurality of submission queues, in the event a storage controller cannot locate the affected commands in their respective submission queues, the storage controller may insert a command barrier to the tail of each affected submission queue. If the controller reaches the command barrier without finding a given affected command on a submission queue, it can determine that the affected command(s) were already completed and transmitted a completion queue on a host.

Methods and systems may perform one or more operations for solid state device command execution including, but not limited to: receiving, in at least one administrative command queue, at least one administrative command affecting at least one submission queue; halting enqueuing of one or more submission commands in the at least one submission queue in response to the receiving the at least one administrative command affecting the at least one submission queue; adding at least one barrier command to at least one submission queue affected by the at least one administrative command; and processing one or more commands in the at least one submission queue until the at least one barrier command in the at least one submission queue is processed; processing the at least one administrative command affecting the at least one submission queue in response to the processing of the at least one barrier command.

### BRIEF DESCRIPTION OF DRAWINGS

The numerous advantages of the disclosure may be better understood by those skilled in the art by referencing the accompanying figures in which:

FIG. 1 illustrates a NVMe command execution system;

FIG. 2 illustrates a NVMe command execution system;

FIG. 3 illustrates a NVMe command execution system;

FIG. 4 illustrates a process flow diagram for NVMe command execution;

FIG. 5 illustrates a process flow diagram for NVMe command execution.

### DETAILED DESCRIPTION

NVMe is a scalable host controller interface designed to address the needs of Enterprise and Client systems that utilize PCI Express based solid state drives. The interface provides an optimized command issue and completion path. It includes support for parallel operation by supporting up to 64K commands within an I/O Queue. Additionally, support has been added for many Enterprise capabilities like end-to-end data protection (compatible with T10 DIF and DIX standards), enhanced error reporting, and virtualization.

The interface has the following key attributes: 1) Does not require uncacheable/MMIO register reads in the command issue or completion path; 2) A maximum of one MMIO register write by the host is necessary in the command issue path; 3) Support for up to 64K I/O queues, with each I/O queue supporting up to 64K commands; 4) Priority associated with each I/O queue with well defined arbitration mechanism; 5) All information to complete a 4 KB read/write command is included in the 64B command itself, ensuring efficient small random I/O operation; 6) Efficient and streamlined command set; 7) Support for MSI/MSI-X and interrupt aggregation; 8) Support for multiple namespaces; and 9) Efficient support for I/O virtualization architectures like SR-IOV; 10) Robust error reporting and management capabilities.

The specification defines a streamlined set of registers whose functionality includes: 1) Indication of controller capabilities; 2) Status for device failures (command status is processed via CQ directly); 3) Administrative Queue configuration (I/O Queue configuration processed via Administrative commands); and 4) Doorbell registers for scalable number of Submission and Completion Queues

The capabilities that the controller supports are indicated in the Controller Capabilities (CAP) register and as part of the Controller and Namespace data structures returned in the Identify command. The Identify Controller data structure indicates capabilities and settings that apply to the entire controller. The Identify Namespace data structure indicates capabilities and settings that are specific to a particular namespace.

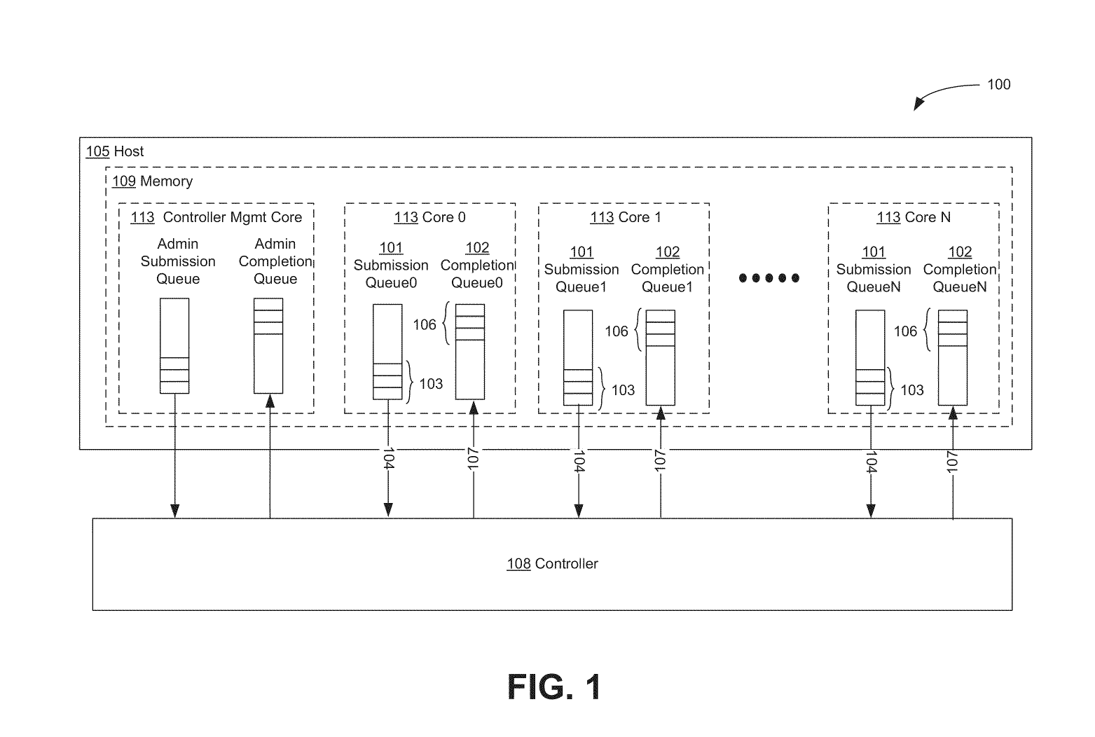

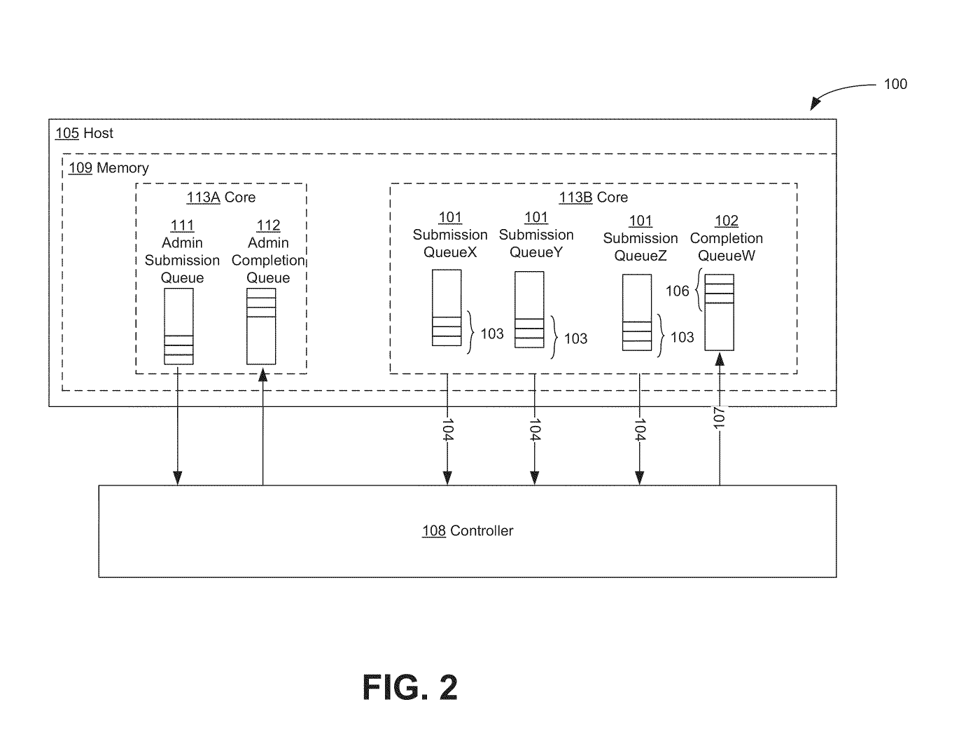

Referring to FIGS. 1-3, an enhanced NVMe system 100 is based on a paired submission queue 101 and completion queue 102 mechanism. One or more submission queue entries 103 associated with commands 104 are placed by software of a host 105 into a submission queue 101. One or more completion queue entries 106 associated with completions 107 are placed into an associated completion queue 102 by an NVMe controller 108. As shown in FIG. 2, multiple submission queues 101 may utilize the same completion queue 102. The submission queues 101 and completion queues 102 may be allocated in host memory 109.

A submission queue 101 may be a circular buffer with a fixed slot size that a host 105 uses to submit commands 104 for execution by the NVMe controller 108. The host 105 updates an appropriate doorbell register of the NVMe controller 108 associated with a submission queue 101 when there are new commands 104 to execute. The previous doorbell register value is overwritten in the NVMe controller 108 when there is a new doorbell register write associated with a given submission queue 101. The NVMe controller 108 fetches commands 104 from the host memory 109 in an order specified by a submission queue 101. However, it may then execute those commands 104 in any order.

Each submission queue entry 103 may be 64 bytes in size. The physical memory locations in the host memory 109 to use for data transfers are specified using Physical Region Page (PRP) entries. Each submission queue entry 103 may include two PRP entries. If more than two PRP entries are necessary to describe the data buffer, then a pointer to a PRP List that describes a list of PRP entries is provided.

A completion queue 102 is a circular buffer with a fixed slot size used to post status for completed commands 104. A completed command 104 is uniquely identified by a combination of an associated submission queue 101 identifier and command 104 identifier that is assigned by host 105 software. As shown in FIG. 2, multiple submission queues 101X-Z may be associated with a single completion queue 102W. This feature may be used where a single worker thread processes all completions 107 for commands 104 via one completion queue 102 even when those commands 104 originated from multiple submission queues 101. A completion queue 102 head pointer may be updated by host 105 software after it has processed completion queue entries 106 indicating the last free completion queue entry 106. A Phase (P) bit is defined in a completion queue entry 106 to indicate whether an entry has been newly posted without consulting a register. This may enable host 105 software to determine whether the new entry was posted as part of the previous or current round of completion notifications. Specifically, each round through the completion queue 102 locations, the NVMe controller 108 may invert the Phase bit.

An administrative submission queue 110 and an associated administrative completion queue 111 may be employed for the purpose of device management and control—e.g., creation and deletion of submission queues 101 and completion queues 102, aborting commands 104, etc. Only commands 104 that are part of an administrative command set may be issued to the administrative submission queue 110. An I/O command set is used with an I/O queue pair of a submission queue 101 and a completion queue 102. This specification defines one I/O Command Set, named the NVM Command Set.

Software employed by the host 105 may create submission queues 101 and completion queues 102, up to the maximum supported by the NVMe controller 108. Typically the number of submission queues 101 created is based on the system configuration and anticipated workload (e.g. a number of available processing cores 112). For example, on a four core processor based system, there may be a submission queue 101/completion queue 102 pair per core to avoid locking and ensure data structures are created in the appropriate processor core's cache. FIG. 1 provides a graphical representation of a queue pair mechanism, showing a 1:1 mapping between submission queues 101 and completion queues 102. FIG. 2 shows an example where multiple submission queues 101 on a common core 112B utilize a common completion queue 102.

NVMe is a flexible specification allowing solutions to be built that span the needs of Client and Enterprise market segments.

In an NVMe system 100, there may be no guaranteed order in the execution and completion of NVMe commands 104. For example, a first command 104 received at a given point in time may be processed either before or after a second command 104 received at a later point in time. Also it may be difficult for an NVMe controller 108 to reset its submission and/or completion pipelines because it has no knowledge if there are residual commands 104 and/or completions 107 in it because of the asynchronous nature of the interface between the controller 108 and the host 105.

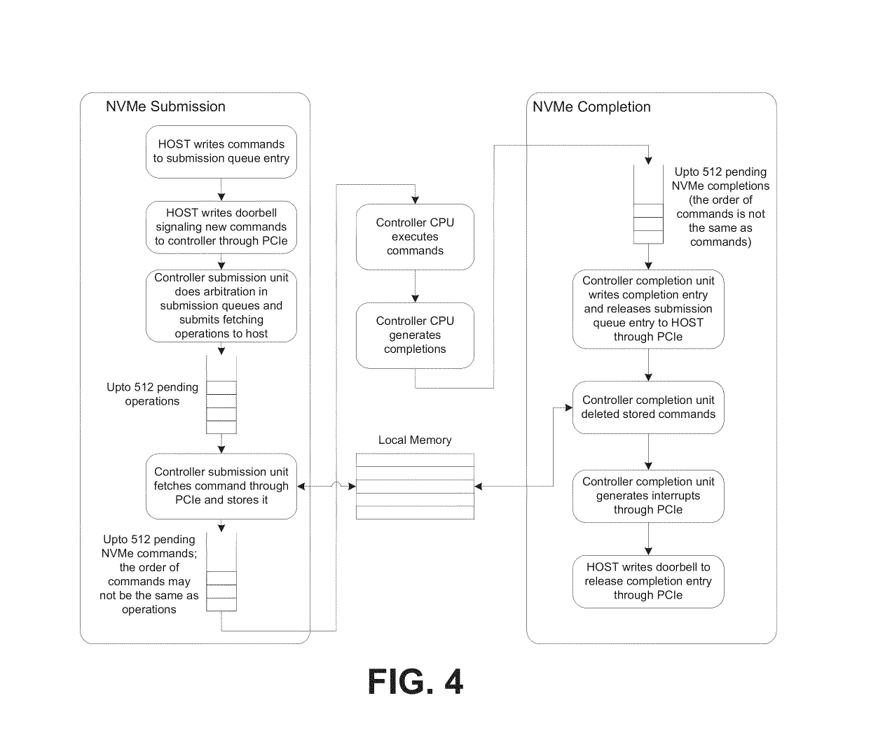

Referring to FIG. 4, a flow diagram representing general NVMe operation is shown.

When a host 105 wants to send an NVMe command 104, it creates a new submission queue entry 103 in a submission queue 101 located in host memory 109. Then host 105 writes to a tail pointer associated with a submission queue 101 in the address space of the NVMe controller 108 to indicate the new command 104 is available through a PCIe memory write command.

When a submission unit 113 of the NVMe controller 108 receives a new tail pointer associated with a submission queue 101, the submission unit 113 may perform arbitration and prepare a fetch operation for the granted submission queue 101 from host memory 109. These fetch operations may be buffered in a FIFO queue of the submission unit 113 of the NVMe controller 108.

Per each fetch operation, the submission unit 113 may send a PCIe memory read command to the host 105 to fetch a command 104 from a command memory 114 portion of the host memory 109. One command 104 may require several PCIe transactions (read or write) and these transactions can be out of order. Therefore, they are saved in a local command memory 115 and re-assembled.

Each returned command 104 may be saved in a memory of the submission unit 113 of the NVMe controller 108 and its handle is buffered in a FIFO until they can be processed by the CPU 116.

A central processing unit (CPU 116) of the NVMe controller 108 may control other internal data moving blocks (e.g. DMA block) to execute the command 104 (e.g. SSD write, SSD read and SSD flush commands) and generate a corresponding completion 107 once it's finished.

These completions 107 may reside in a completed command FIFO waiting for a completion unit 117 of the NVMe controller 108 to process them.

The completion unit 117 may write a completion 107 to a completion memory 118 in the host memory 109 and deletes the saved command 104 from the local command memory 115.

After the completion queue entry 106 write is posted to PCIe, the completion unit 117 may signal a PCIe interrupt unit 119 to generate an interrupt 120 to the host 105.

On the host 105 side, when the host 105 has consumed a completion 107, it writes to a head pointer associated with the completion queue 102 in the completion unit 117 address space of the NVMe controller 108 to indicate that some number of completion queue entries 106 have been processed.

When the completion unit 117 receives the head pointer update, it updates the head pointer for the completion queue 102 to release the corresponding completion queue entry 106.

In the NVMe system 100, except for commands 104 that are part of a fused operation (i.e. combine two commands into one), each command 104 may be processed as an independent entity without reference to other commands 104 issued by the same submission queue 101 or to commands 104 issued to other submission queues 101. Therefore, there is no guaranteed order of processing by the CPU 116 between any two commands 104 or completions 107.

NVMe commands 104 may be pipelined in different stages and there is no easy way for an NVMe controller 108 to tell the status of the submission pipeline. For example, NVMe commands 104 may be: in the command memory 114 and the NVMe controller 108 is not yet aware of the command 104; in the command memory 114 but not yet fetched by the NVMe controller 108; in command memory 114 but only partially fetched by the NVMe controller 108; fully fetched and saved in NVMe controller 108 but not executed yet; and/or saved and executed in NVMe controller 108.

Similarly NVMe completions 107 may be pipelined in different stages and there is no easy way for NVMe controller 108 to tell the status of completion pipeline. For example, NVMe completions 107 may be: in completion unit 117 memory and a host 105 is not yet aware of the completion 107; and/or in completion memory 118.

In case of errors, it may be difficult for the NVMe controller 108 to reset its pipeline because it has no knowledge if there are residual commands retained within it.

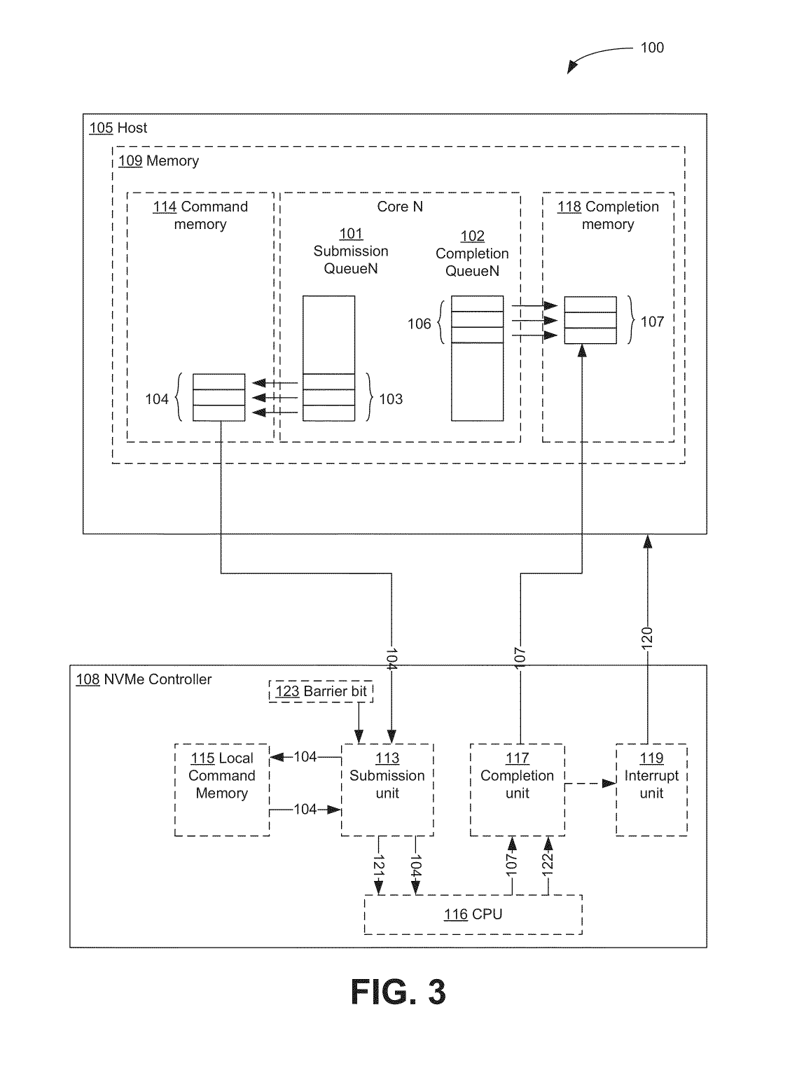

Referring to FIG. 3, in addition to normal NVMe commands 104/completion queue entries 106, an NVMe barrier operation may be introduced. Instead of NVMe commands 104 generated by host 105, the NVMe controller 108 may generate a barrier command 121 and/or a barrier completion 122. The NVMe controller 108 employs various barriers where the barrier command 121 is always the last command 104 in the submission queue 101 pipeline and the barrier completion 122 is always the last completion 107 in the completion queue 102 pipeline.

In one embodiment, it may be desirable to insert a barrier command 121 into the command pipeline in various situations. For example, it may be the case that a host 105 may attempt to delete one of the NVMe queues (e.g. a submission queue 101). The host 105 may generate an administrative command corresponding to the deletion of the NVMe queue which may be added to the administrative submission queue 110. In response to the enqueuing of an administrative command affecting one or more submission queues 101 in the administrative submission queue 110, the submission unit 113 may generate an interrupt to the CPU 116 and the CPU 116 may generate a barrier command 121 for a submission queue 101 to be deleted. The submission unit 113 may halt fetching any more commands 104 for the submission queue 101 to be deleted until the barrier command 121 associated with that submission queue 101 has been processed. Once the CPU 116 processes the barrier command 121 associated with that submission queue 101, the status of the submission queue 101 is known (i.e. that no further commands 104), the CPU 116 can clear any status/registers related to submission queue 101 in the pipeline and inform the host 105 the deletion is complete.

In some embodiments, it may be desirable to insert a barrier command 121 into the command pipeline in response to a request from the host 105 to abort one or more commands the host 105 has pending. The host 105 may generate an administrative command corresponding to the abort of an NVMe command which may be added to the administrative submission queue 110. In response to the enqueuing of an administrative command affecting one or more submission queues 101 in the administrative submission queue 110, the submission unit 113 may generate an interrupt to the CPU 116. The CPU 116 may attempt to determine the state of the commands to be aborted. In order to determine if the commands to be aborted are still in the submission queue 110 and not yet received by the CPU 116, the CPU 116 may generate a barrier command 121 for a submission queue 101 which may contain the command to be aborted. The submission unit 113 may halt fetching any more commands 104 for the submission queue 101 until the barrier command 121 associated with that submission queue 101 has been processed. Once the CPU 116 processes the barrier command 121 associated with that submission queue 101, the status of the submission queue 101 is known (i.e. that no further commands 104), the CPU 116 can clear any status/registers related to submission queue 101 in the pipeline and inform the host 105 the status of the aborted command which may have been found prior to the processing of the barrier command 121.

In another case, a host 105 may attempt to perform an NVMe level reset (as opposed to a full chip reset) which is analogous to a deletion of all submission queues 101. In this case, the CPU 116 may generate a barrier command 121 for all submission queues 101. Once a barrier command 121 for each submission queue 101 is processed, the CPU 116 can reset the entire submission pipeline.

In yet another case, a host 105 may attempt to place the NVMe controller 108 in to a low power mode as soon as possible. The CPU 116 may use a barrier command 121 to flush the submission pipeline and then reduce or remove the power to that pipeline.

In another embodiment, it may be desirable to distinguish commands 104 fetched before and after a given point in time. For example, when a host 105 attempts to modify an arbitration scheme for the submission queues 101 to a different scheme(e.g. from round robin to weighted round robin), the CPU 116 may receive an interrupt, insert a barrier command 121 into the necessary submission queues 101 and change the arbitration scheme. When the CPU 116 processes the barrier command 121 for each affected submission queue 101, it is an indication that the arbitration scheme has been successfully modified and the new arbitration scheme may be employed for subsequent commands 104.

The reception of a barrier indicates an empty pipeline which is ready for reset. Moreover, in normal operation other than error case, the NVMe controller 108 may use the barrier command 121 as a boundary to distinguish commands which are fetched before and after it. Any commands 104 that are fetched before a barrier command 121 are always executed and completed before any commands 104 that are fetched after the barrier command 121.

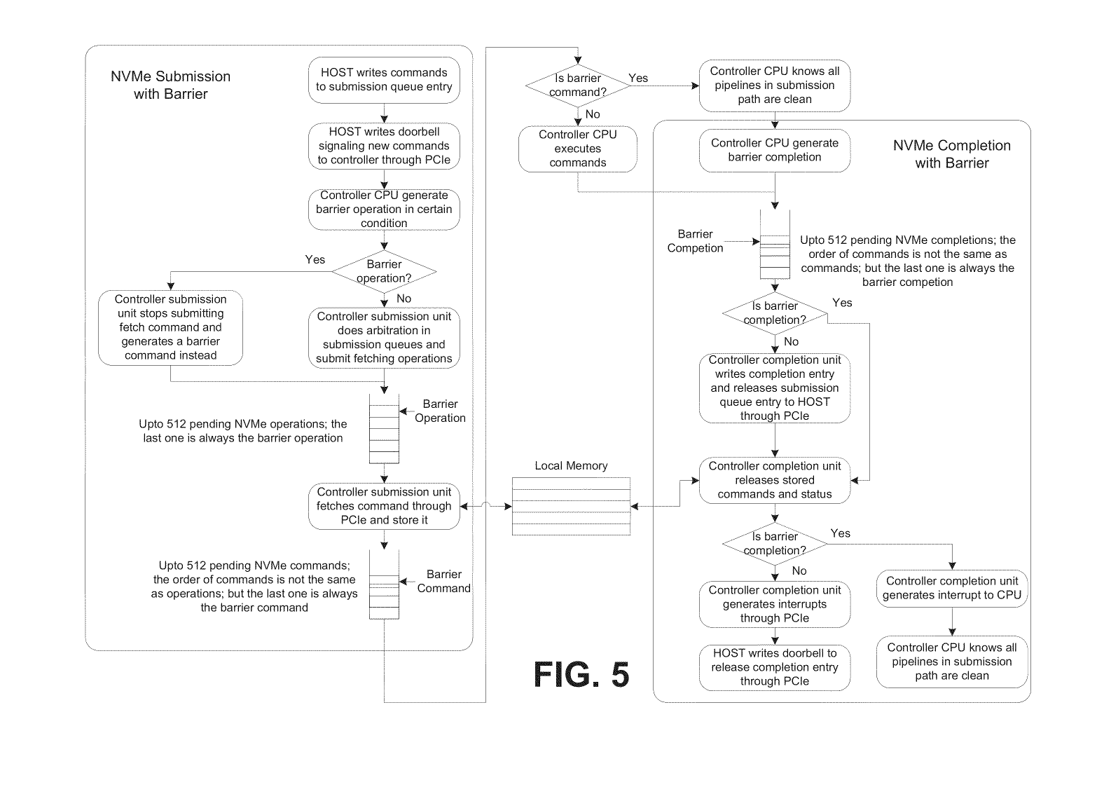

Referring to FIG. 5, a flow diagram representing additional NVMe system 100 operations is shown. In addition to the described NVMe system 100 operations of FIG. 5, a barrier command 121 may be introduced.

Before the submission unit 113 generates any new fetch operations, it may look to a barrier bit 123. The transit of barrier bit 123 from a 0 to 1 may indicate that the NVMe controller 108 wants the submission unit 113 to insert a barrier command 121. NVMe controller 108 may clear the barrier bit 123 first and then set it for barrier command 121 generation.

The submission unit 113 of the NVMe controller 108 may cease generating any new fetch operation and generates a barrier command 121. This barrier command 121 is the last command in the submission pipeline.

When the CPU 116 of the NVMe controller 108 finished executions of all commands 104 and it sees a barrier command 121, it knows there are no longer any pending commands 104 in the submission pipeline

Then CPU 116 of the NVMe controller 108 may then generate a barrier completion 122 which is the last completion in the completion pipeline. When completion unit 117 has finished all completions 107 and it sees a barrier completion 122, it will generate an interrupt 120 to inform the CPU 116 that all there are no longer any pending completions 107 in the completion pipeline

As previously noted, in general, the completion of commands 104 can be out of order with respect to their submission. The use of a barrier command 121 provides a simple but efficient mechanism for the NVMe controller 108 to force ordering of commands 104 when the strict ordering is required. Any commands 104 that are fetched before a barrier command 121 are always executed and completed before any commands 104 that are fetched after the barrier command 121.

Further, it provides a simple but efficient mechanism for the NVMe controller 108 to flush both NVMe submission and completion pipelines without losing any commands 104.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It may be the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art has progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

What is claimed:

1. A method for solid state device administrative command execution, comprising:
receiving, in at least one administrative command queue, at least one administrative command affecting at least one submission queue;
adding at least one barrier command to at least one submission queue affected by the at least one administrative command;
processing one or more commands in the at least one submission queue until the at least one barrier command in the at least one submission queue is processed; and
processing the at least one administrative command affecting the at least one submission queue in response to the processing of the at least one barrier command.

2. The method of claim 1, wherein the at least one administrative command affecting at least one submission queue and the one or more submission commands are Non-Volatile Memory Express (NVMe) commands.

3. The method of claim 1, wherein the at least one administrative command affecting at least one submission queue includes a command for at least one of:
submission queue creation, submission queue deletion, completion queue addition, completion queue addition, or aborting at least one submission queue command.

4. The method of claim 1, wherein the at least one administrative command affecting at least one submission queue includes a command for:
modifying at least one arbitration scheme associated with processing submission commands of two or more submission queues.

5. The method of claim 1, further comprising:
halting enqueuing of one or more submission commands in the at least one submission queue in response to the receiving the at least one administrative command affecting the at least one submission queue.

6. The method of claim 5, further comprising:
resuming enqueuing of or more submission commands to the at least one submission queue in response to completion of processing of the at least one administrative command affecting the at least one submission queue.

7. The method of claim 1, wherein the processing one or more commands in the at least one submission queue until the at least one barrier command in the at least one submission queue is processed includes:
generating at least one barrier completion in response to completion of processing the at least one administrative command affecting the at least one submission queue; and
storing the at least one barrier completion in at least one completion queue.

8. A system for solid state administrative command execution, comprising:
at least one computing device; and
one or more instructions that, when implemented in the computing device, configure the computing device for:
receiving, in at least one administrative command queue, at least one administrative command affecting at least one submission queue;
halting enqueuing of one or more submission commands in the at least one submission queue in response to the receiving the at least one administrative command affecting the at least one submission queue;
adding at least one barrier command to at least one submission queue affected by the at least one administrative command;
processing one or more commands in the at least one submission queue until the at least one barrier command in the at least one submission queue is processed; and
processing the at least one administrative command affecting the at least one submission queue in response to the processing of the at least one barrier command.

9. The system of claim 8, wherein the at least one administrative command affecting at least one submission queue and the one or more submission commands are Non-Volatile Memory Express (NVMe) commands.

10. The system of claim 8, wherein the at least one administrative command affecting at least one submission queue includes a command for at least one of:
submission queue creation, submission queue deletion, completion queue addition, completion queue addition, or aborting at least one submission queue command.

11. The system of claim 8, wherein the at least one administrative command affecting at least one submission queue includes a command for:
modifying at least one arbitration scheme associated with processing submission commands of two or more submission queues.

12. The system of claim 8, further comprising:
halting enqueuing of one or more submission commands in the at least one submission queue in response to the receiving the at least one administrative command affecting the at least one submission queue.

13. The system of claim 12, further comprising:
resuming enqueuing of or more submission commands to the at least one submission queue in response to completion of processing of the at least one administrative command affecting the at least one submission queue.

14. The system of claim 8, wherein the processing one or more commands in the at least one submission queue until the at least one barrier command in the at least one submission queue is processed includes:
generating at least one barrier completion in response to completion of processing the at least one administrative command affecting the at least one submission queue; and
storing the at least one barrier completion in at least one completion queue.

15. A system for solid state device administrative command execution, comprising:
at least one solid state storage device;
a controller device configured for:
receiving, in at least one administrative command queue, at least one administrative command affecting at least one submission queue;
halting enqueuing of one or more submission commands in the at least one submission queue in response to the receiving the at least one administrative command affecting the at least one submission queue;
adding at least one barrier command to at least one submission queue affected by the at least one administrative command;
processing one or more commands in the at least one submission queue until the at least one barrier command in the at least one submission queue is processed; and
processing the at least one administrative command affecting the at least one submission queue in response to the processing of the at least one barrier command.

16. The system of claim 15, wherein the at least one administrative command affecting at least one submission queue and the one or more submission commands are Non-Volatile Memory Express (NVMe) commands.

17. The system of claim 15, wherein the at least one administrative command affecting at least one submission queue includes a command for at least one of:
submission queue creation, submission queue deletion, completion queue addition, completion queue addition, or aborting at least one submission queue command.

18. The system of claim 15, wherein the at least one administrative command affecting at least one submission queue includes a command for:
modifying at least one arbitration scheme associated with processing submission commands of two or more submission queues.

19. The system of claim 15, further comprising:
halting enqueuing of one or more submission commands in the at least one submission queue in response to the receiving the at least one administrative command affecting the at least one submission queue;

20. The system of claim 19, further comprising:
resuming enqueuing of or more submission commands to the at least one submission queue in response to completion of processing of the at least one administrative command affecting the at least one submission queue.
